(19) United States
(12) Patent Application Publication
(10) Pub. No.: US 2023/0330610 A1
(43) Pub. Date: Oct. 19, 2023

(54) STIRRER ASSEMBLY AND METHOD OF MAINTAINING A LIQUID FORMULATION IN A MIXED CONDITION

(71) Applicant: Atlas Diversified Products Corp., Lansing, MI (US)

(72) Inventors: Kirby Adams, Eaton Rapids, MI (US); Mark A. Ledebuhr, Lansing, MI (US); Nicholas C. Tipper, Saint Johns, MI (US)

(21) Appl. No.: 18/339,363

(22) Filed: Jun. 22, 2023

Related U.S. Application Data
(63) Continuation-in-part of application No. PCT/IB2021/060419, filed on Nov. 10, 2021.
(60) Provisional application No. 63/136,399, filed on Jan. 12, 2021.

(51) Int. Cl. B01F 27/90; B01F 35/32; B01F 27/112; B01F 27/072; B01F 35/45

(52) U.S. Cl. CPC B01F 27/90; B01F 27/0722; B01F 27/112; B01F 35/3204; B01F 35/45

(57) ABSTRACT

A stirrer assembly for use with a vessel, such as a keg, having an access opening. The vessel includes a cover that is adapted to close the access opening and has a through-hole therein. A stirrer assembly is adapted to releasably engage the through-hole and to be engaged by a motor. The stirrer assembly includes a driven shaft that extends in to a lower portion of the vessel with a paddle releasably mounted at a distal portion of the driven shaft.

### CROSS REFERENCE TO RELATED APPLICATIONS

The present application is a continuation-in-part of International Patent Application Serial No. PCT/IB2021/060419 filed Nov. 10, 2021, which claims the benefit of U.S. Provisional Pat. Application Seri. No. 63/136,399 filed Jan. 12, 2021, the disclosures of which are hereby collectively incorporated herein by reference in their entirety.

### BACKGROUND OF THE INVENTION

The present invention is directed to a stirrer assembly and method for maintaining beverage ingredients or other liquid in a mixed condition and, in particular, to a stirrer for use with a vessel, such as a keg, including a keg with a Cornelius or Racetrack style opening, collectively referred to as a Cornelius keg. Cornelius and Racetrack kegs are similar in design but have slightly different cover geometry. In vessels, such as kegs, pressurized gas is applied to an inlet port to dispense the fluid contained in the keg from an outlet port. Proper sealing is required to allow for the mixed fluid contents to be dispensed properly from the outlet port. Loss of dispensing gas should be minimized for financial and aesthetic reasons, as well as for an undesirable modification of the fluid contents when the gas plays a role in the end-use fluid product, such as carbonation in a beverage.

Bars and beverage establishments that serve high volumes of any given type of cocktail or other type of beverage that contains a heterogeneous mixture of ingredients can significantly increase their throughput and therefore profit if they can pre-mix kegs of that mixture. Stirring is important for recipes that contain ingredients that may be prone to separate, such as unfiltered fruit or vegetable juices, bitters, herbals powders, emulsions or other non-soluble flavors, color or textural components. Failure to keep these ingredients uniformly in suspension gives both an inferior dispensed product and also may be illegal in some states as the bartender cannot verify how much alcohol is in the final drink. There are states that require bars to shake or otherwise agitate a keg before they serve from it to solve this problem. Since many kegs are not easily accessible when dispensing, this requirement is impractical. These solutions have their respective deficiencies.

Cornelius kegs are also commonly used as tanks where small batches of non-beverage liquids, such as emulsions and suspensions, in un-agitated containers need to be mixed before dispensing. Magnetic stirrers, such as lab stirrers, expensive custom vessels, and modified drop tubes that bubble the keg using pressurized gas propellant as fluid is drawn out have been used. Lab stirrers require specially designed nonstandard kegs and an expensive and bulky power unit. Custom vessels with built-in agitation are expensive and can be difficult to clean. The agitation provided by bubbling may not provide enough mixing energy to completely agitate the mixture. Further, while the present disclosure is directed to stirrers for kegs, the stirrers described herein can be used in other vessels where mixing is desirable, such as agricultural applications.

### SUMMARY

The stirrer assembly disclosed herein solves deficiencies using alternative solutions to those noted above with a simple, sanitary and robust solution that is compatible to existing vessels. The present disclosure provides a stirrer assembly and method of maintaining a liquid formulation in a mixed condition wherein the stirrer assembly mounts in the vessel cover, and not the wall of the vessel. It can be manually removed prior to removing the cover so that the stirring shaft does not create an obstacle to opening and removing the cover. The parts can be easily separated for cleaning.

In one form, the vessel is pressurized, and the cover is configured to maintain the pressurization of the vessel. For example, the vessel may comprise a keg.

Embodiments of the disclosure have many advantages. It is intrinsically safe: if the cover fails, the vessel just depressurizes. In the case of a keg, prior modified kegs come at a very high cost, and if the modification fails, the keg could potentially rupture thereby causing property damage. Also, some embodiments can operate on low power, such as 12 volt or 24 volt direct current. The stirrer assemblies can be added to any Cornelius style keg from 2 to 15 gallons by simply using a different length shaft. In one embodiment, the stirrer assembly uses a modified cover, which is fully interchangeable with all Cornelius style kegs. It can be disassembled in seconds, so it adds virtually no complication to keg management. It can be swapped to the next full keg in seconds, so the number of stirrers needed is only 1 per active keg.

In one embodiment, a stirrer assembly for use with a keg, includes stirrer and a cover that is adapted to close the top of the keg. The cover has a through-hole therein through which the stirrer assembly extends into the keg. The stirrer assembly is adapted to releasably engage the through-hole of the cover and includes a motor drive shaft that extends to a lower portion of the keg and has at least one paddle at a distal portion of the shaft for stirring the liquid mixture in the keg.

The stirrer assembly may engage the through-hole with mated threaded connection. One or more seals may be provided at the mated threaded connection. At least one paddle may be pivotally mounted to the shaft of the stirrer assembly. The at least one paddle may have a foil shaped surface that when rotated in the liquid causes the paddle to pivot into an orientation generally perpendicular to the shaft. The shaft may be releasably coupled to a motor via a socket on the motor or the shaft and a mating hub on the other of the motor and shaft. For example, the stirrer assembly may include a coupling on the shaft, which forms the socket to be engaged by the motor shaft. A removable pin may be provided that is adapted to maintain the engagement between the motor and the stirrer assembly shaft.

A method of maintaining a liquid formulation in a mixed condition, the formulation comprising a liquid and a substance that is prone to separation from the liquid, according to an aspect of the invention, includes providing the formulation in a keg having cylindrical walls defining an access opening and closing the access opening with a cover having a through-hole therein. A stirrer is positioned in the through-hole with the cover closing the access opening. The stirrer has a motor with a driven shaft extending to a lower portion of the keg and a paddle at a distal portion of said shaft extension. At least occasionally the stirrer is operated in order to maintain the substance mixed with the liquid.

In one form, the keg is pressurized, and the cover is configured to maintain the pressurization of the keg.

The keg may be replenished by withdrawing the stirrer and removing the cover. The stirrer may engage with said through-hole with a mated threaded connection. The motor assembly may be manually rotated to disengage and reengage the mated threaded connection. Also, the motor assembly may be configured to be separated from the shaft and the motor assembly moved to another stirrer on a different keg. This allows the keg to be supplied with a preinstalled stirrer assembly without a motor assembly. A keg could then be interchanged without requiring an additional motor assembly.

The liquid formulation may be an alcoholic beverage, tea mixtures and the like for dispensing to patrons. The method may be used in a variety of industrial settings, such as research laboratories, pharmaceutical manufacturers, agricultural applications, and the like.

These and other objects, advantages, purposes and features of this invention will become apparent upon review of the following specification in conjunction with the drawings.

### BRIEF DESCRIPTION OF THE DRAWINGS

FIG. 1 is a perspective view of a keg assembly according to an embodiment of the invention;

FIG. 2 is a cross-sectional view taken along the lines II-II in FIG. 1;

FIG. 3 is the same view as FIG. 1 of the upper portion of the keg and stirrer assembly;

FIG. 4 is a cross-sectional view taken along the lines IV- IV in FIG. 3;

FIG. 5is the same view as FIG. 3 showing the stirrer assembly withdrawn from the keg cover;

FIG. 6 is a cross-sectional view taken along the lines VI-VI in FIG. 5;

FIG. 7 is the same view as FIG. 5 with the stirrer separated from the electric motor;

FIG. 8 is a cross-sectional view taken along the lines VIII-VIII in FIG. 7;

FIG. 9 is a side elevation view of a keg assembly with another embodiment of a stirrer assembly;

FIG. 10 is a sectional view taken along the lines X-X in FIG. 9;

FIG. 11 is another side elevation view the keg assembly of FIG. 9;

FIG. 12 is a cross-sectional view taken along the lines XII-XII in FIG. 11;

FIG. 13 is an exploded perspective view of the stirrer assembly and motor assembly;

FIG. 13A is an enlarged side view of the paddle mounting arranging on the shaft of the stirrer assembly showing the paddles in a folded configuration;

FIG. 13B is an enlarged side view of the paddle mounting arranging similar to FIG. 13A showing the paddles in a raised configuration;

FIG. 13C is an exploded perspective view of the paddles and the paddle mounting bracket;

FIG. 14 is a cross-sectional view of the stirrer assembly and the motor assembly;

FIG. 15 is an enlarged cross-section of the stirrer assembly coupler that provides an interface with the motor assembly and that seals the stirrer in the cover;

FIG. 15A is an enlarged cross-section of a plug that can be used to close and seal the though-hole in the bushing when the stirrer assembly is removed;

FIG. 16 is an enlarged cross-section of the cover of the keg assembly;

FIG. 17 is an enlarged cross-section of the bushing to be installed or formed in the cover; and

FIG. 18 is an enlarged perspective view of the motor assembly and the stirrer assembly shaft mounting interface.

### DESCRIPTION OF THE PREFERRED EMBODIMENTS

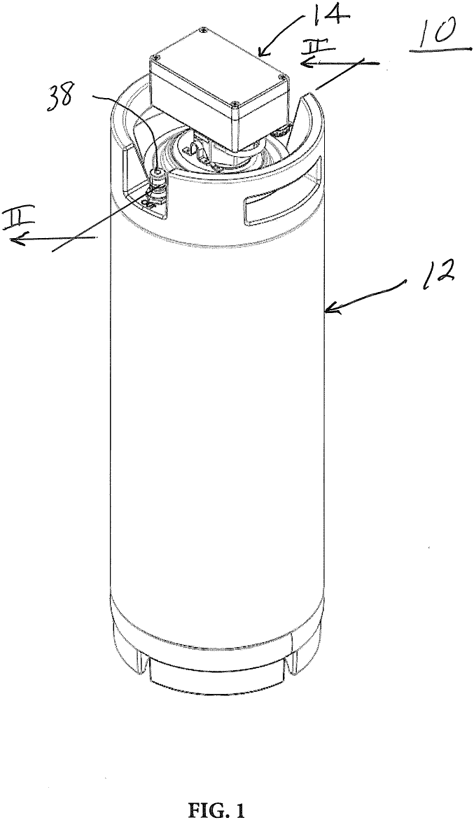

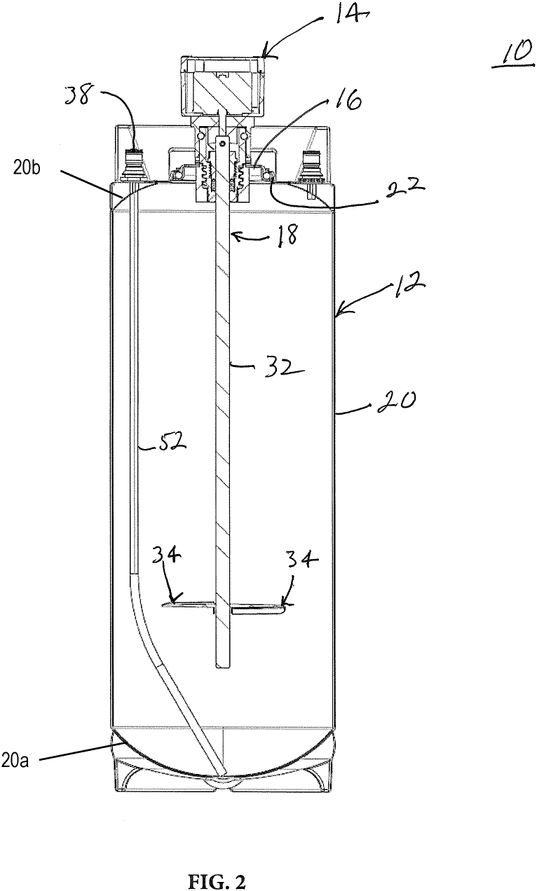

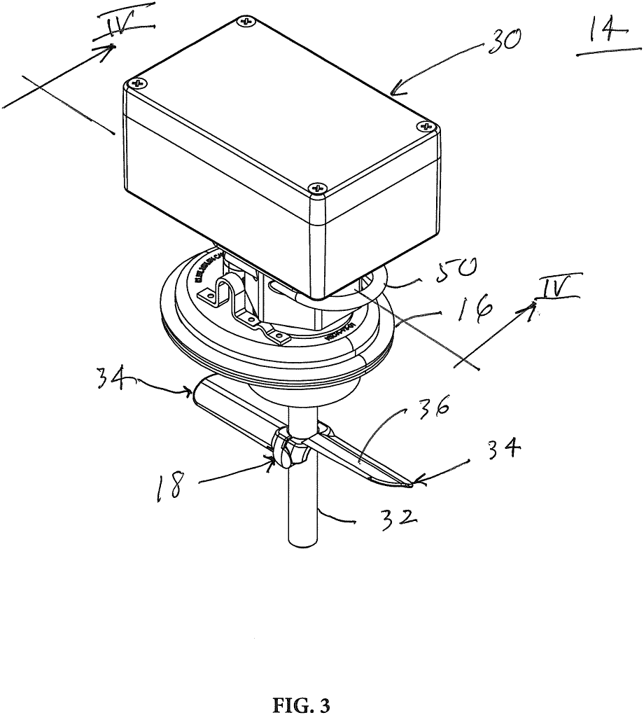

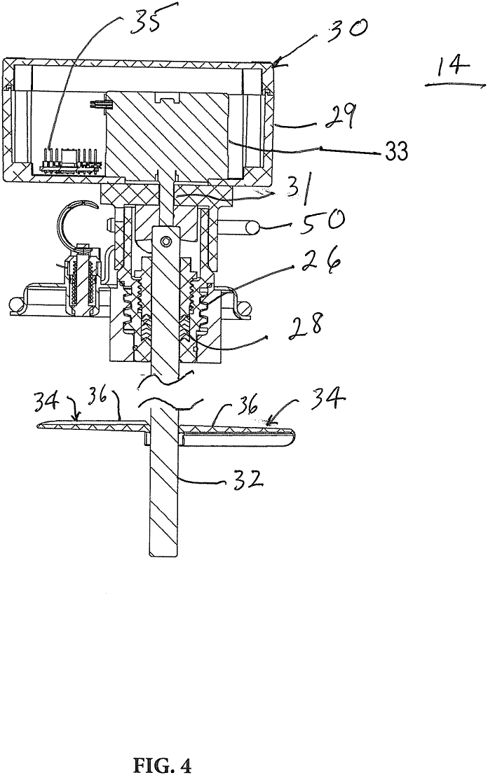

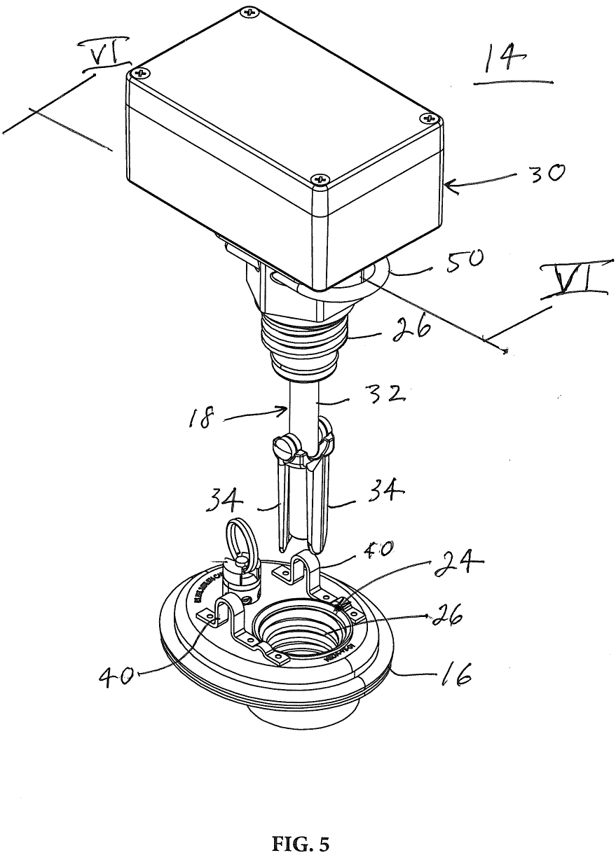

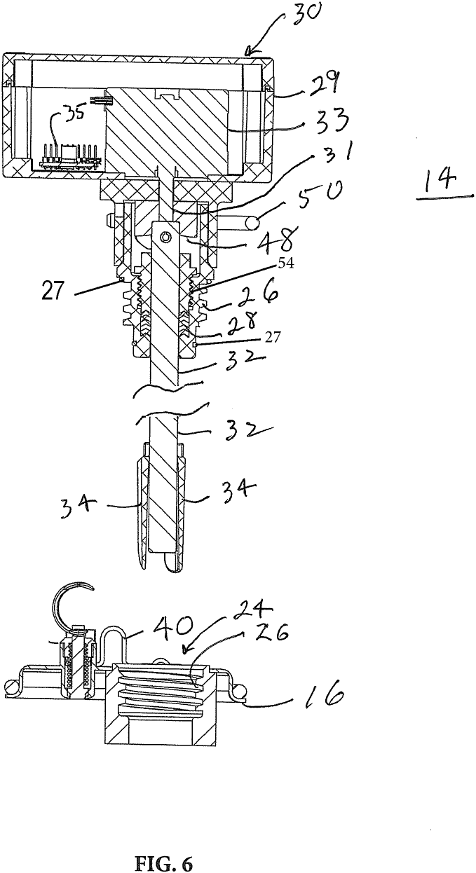

Referring to FIG. 1, the numeral 10 designates a keg assembly with a keg 12 and a stirrer assembly 14 that mixes the liquid in the keg. In the illustrated embodiment, keg assembly 10 includes a keg 12 in the form of a Cornelius keg, though it should be understood that other types of kegs or vessels may be used. As will be more fully described below, stirrer assembly 14 is mounted in the top of the keg so that it is removable for cleaning and, further, extends to the lower end of the keg to mix the liquid contained in the keg, but without interference with the tube 52 that dispenses the mixed fluid from the keg.

Keg 12 includes a cylindrical wall 20, a bottom wall 20a, and an upper wall 20b, which together form a vessel. Upper wall 20b includes an access opening 22, which is closed and sealed by a removable cover 16, which is configured to close access opening 22 in a manner that allows the interior of the keg to be pressurized. Stirrer assembly 14 is removably mounted in cover 16 and includes a stirrer 18 that is driven by an electric motor assembly 30.

To mount stirrer assembly 14 in cover 16, cover 16 includes a through-hole 24 that is configured to receive stirrer 18 there-through and to sealing engage the stirrer 18 with a threaded connection 26 and one or more seals 27. Threaded connection 26 includes mating threads on the stirrer 18 and the cover 16, and seal(s) 27 are O-rings. Stacked V-shaped packing seals 28 are also provided to prevent pressurized gas from escaping around stirrer shaft 32, and a threaded nut 54 allows the packing to be tightened to prevent leakage around the shaft.

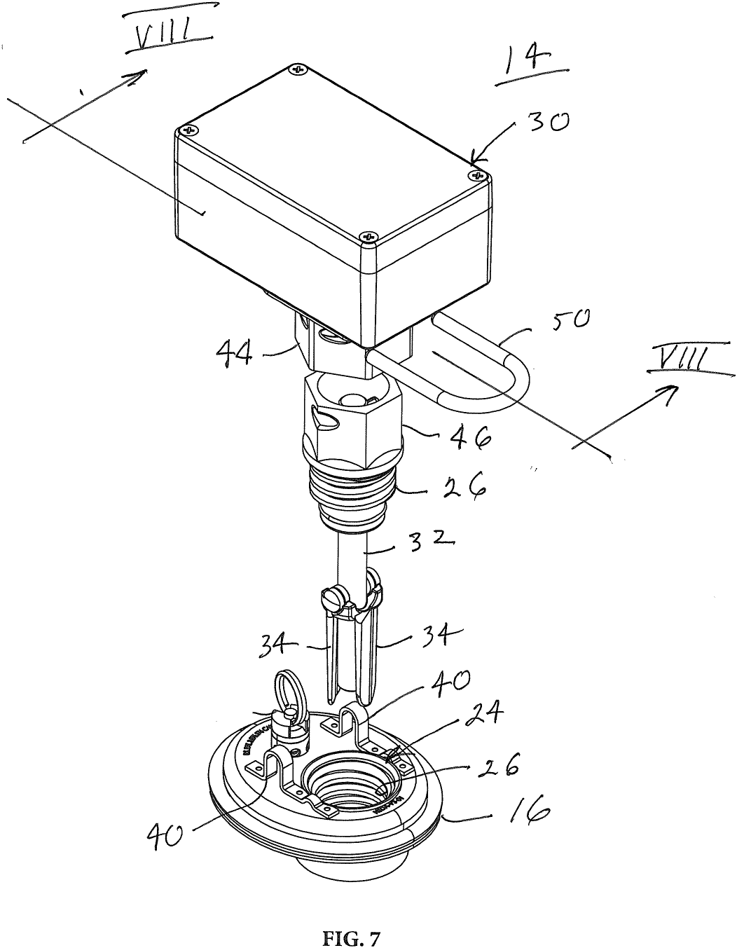

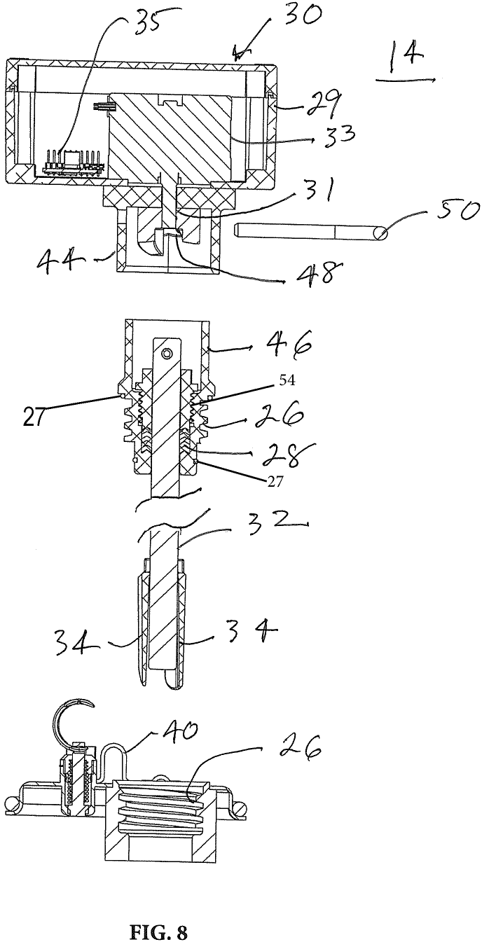

Electric motor assembly 30 in the illustrated embodiment is a 12 or 24 volt stepper motor or brushless DC motor 33 having an output shaft 31. The motor 33 and a speed controller 35 are sealed within a waterproof housing 29. Other types of electric motors would be apparent to the skilled artisan, such as an AC fixed speed gear-motor or the like. A socket 44 attached to housing 29 engages a coupler on the stirrer 18, such as a hub 46, provided at the top of the stirrer 18. Socket 44 also forms a motor coupling 48 for engaging the shaft 32 of stirrer 18. The engagement between socket 44 and hub 46 aligns motor coupling 48 with shaft 32 to transmit torque between the motor 33 and the stirrer 18. Socket 44, however, still allows the stirrer 18 to be separated from the electric motor assembly 30 for cleaning of the stirrer 18, as best seen in FIGS. 7 and 8. When the socket 44 is mated to the hub 46, a u-shaped pin 50 can be inserted into the socket 44 and the hub 46 to lock the assembly together. Output shaft 31 passes through motor coupling 48 within socket 44 and has a mating engagement with stirrer shaft 32 of stirrer 18. Plane bearing surface 48 is configured to absorb any upward thrust of stirrer shaft 32 that may occur from dispensing gas pressure within the keg pushing the stirring shaft upward.

Since stirrer assembly 14 can be used with a variety of sized kegs, stirrer shaft 32 may be provided in various lengths to match the keg in which it will be used. Alternatively, stirrer shaft 32 may have a shaft extension (not shown) which extends toward the lower portion of the interior of keg 12. If one is provided, the shaft extension is coupled to stirrer shaft 32 with a coupling (not shown). Stirrer shaft 32 extends to the lower portion of the interior of keg 12 at which one or more paddles 34 is attached to the shaft. Keg 12 includes a conventional dispensing valve 38 and a tube 52 which extends from dispensing valve 38 to the bottom of keg 12. Dispensing valve 38 opens when a mating fitting (not shown, such is typically connected with a dispensing hose) is connected to it. In order to provide clearance between tube 52 and paddles 34, through-hole 24 is offset from the center of oval-shaped cover 16 to provide spacing between paddles 34 and tube 52. A bale (not shown) is joined to cover 16 by brackets 40 and holds cover 16 securely over access opening 22. Through-hole 24 is also offset on cover 16 to avoid interference of the bale motion when engaging and disengaging the cover seal on the keg. Paddles 34 are pivotally mounted to the stirrer shaft in order to reduce the diameter of the stirrer when the stirrer passes through through-hole 24 for insertion or removal of the stirrer assembly to or from the keg. Each paddle 34 has a foil shaped surface 36 that produces hydrodynamic forces to pivot the paddles to an orientation generally perpendicular to the shaft where it extends to a wider mixing diameter for more effective mixing. Each paddle 34 is made from a flexible material so that it will break away for safety and not damage the drop-tube or vice versa if it interferes with the tube other or other internal structure. The bale may be slightly modified so that the bale does not interfere with motor assembly 30 or stirrer assembly 14.

In use, motor 33 is occasionally operated by an electronic control (not shown) such as when a cocktail is ready to be poured or according to some regular interval, or the like. When the cocktail mix is depleted, stirrer assembly 14 is removed from cover 16 by operating threaded connection 26 and pulling the stirrer 18 out of through-hole 24. Conveniently, motor assembly 30 can be used as a wrench for unthreading and rethreading of the threaded connection 26. Cover 16 can be then removed and the keg cleaned and replenished, or a new pre-mixed keg installed. Cover 16 is then replaced and stirrer assembly 14 reattached to the cover by inserting stirrer 18 in through-hole 24 and threading threaded connection 26. Removal of the stirrer assembly allows the shaft or its extension of sufficient length to fully agitate the keg contents. Were the stirrer assembly to not be removable, it would not be feasible to have a sufficiently long stirrer to open the cover 16 without interference between the shaft and portions of the keg such as the drop-tube or other interior portions of the keg. Once the stirrer assembly 14 is removed from the keg, stirrer 18 can be removed from motor assembly 30 by removing U-shaped pin 50 and separating attachment hub 46 from attachment socket 44 as seen in FIGS. 7 and 8. The stir assembly 14 is also removed to allow for the bale to pivot in brackets 40 without interference from the motor assembly 30 to allow cover 16 removal.

Alternatively, motor assembly 30 may be removed by removing U-shaped pin 50 without extracting stirrer 18 from cover 16. Motor assembly 30 may then be applied to another keg with another cover 16 and stirrer 18 installed. This would allow a user to leave a motor assembly 30 in use while changing an existing keg with a new, filled one without having to open the keg at the point of use.

Cover 16 is removed from keg 12 by a compound motion that involves slanting of the cover with respect to the keg. Such motion would not be practical with stirrer 18 in its use position since the length of the stirrer to proximate the bottom of the keg would make avoiding contact with keg wall 20 impractical. By providing for removal of the stirrer assembly before removal of the keg cover and reinserting after the keg cover is replaced, embodiments of the present invention avoid such interference.

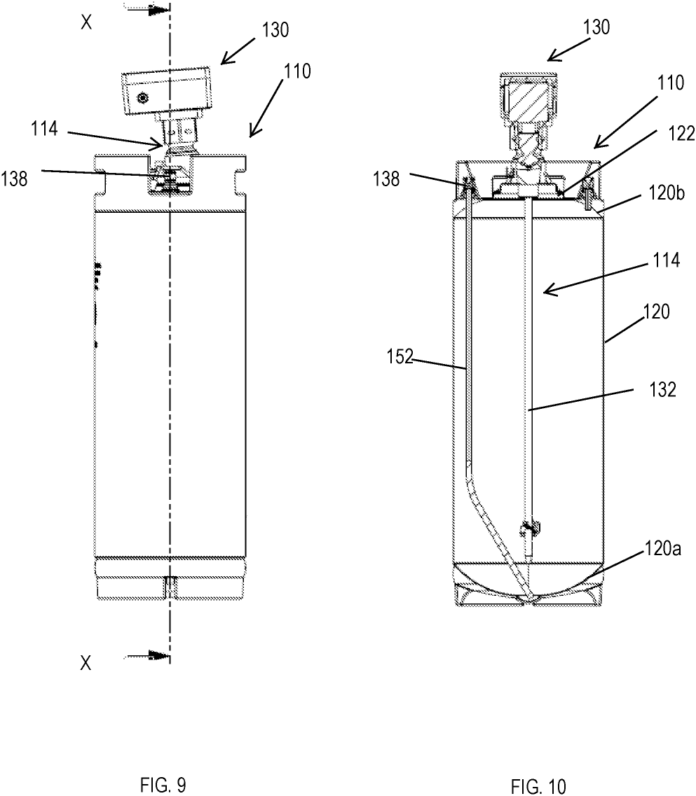

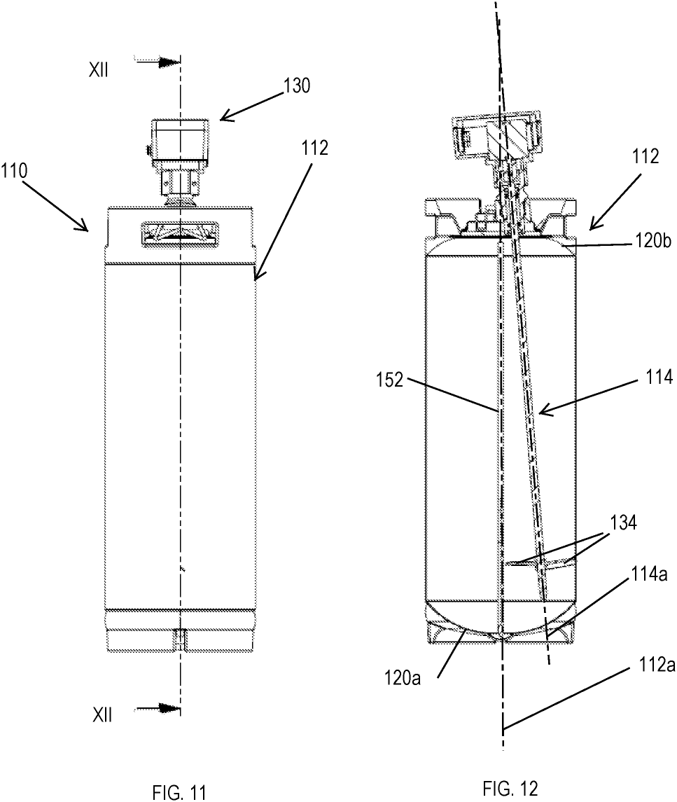

Referring to FIGS. 9 and 10, the numeral 110 designates a keg assembly with a keg 112 and another embodiment of a stirrer assembly 114 that mixes the liquid in the keg 112. Similar to the previous embodiment, keg assembly 110 includes a keg 112 in the form of a Cornelius keg, though it should be understood that other types of kegs or vessels may be used. Stirrer assembly 114 is also removably mounted in the top of the keg so that it is removable for cleaning and extends to the lower end of the keg to mix the liquid contained in the keg. As will be more fully described below, stirrer assembly 114 is extended and oriented in keg 112 to avoid, if not eliminate, interference with the tube 152 and, further, position its mixing paddles 134 closer to the bottom of keg 112 to improve mixing performance.

Similar to keg 12, keg 112 includes a cylindrical wall 120, a bottom wall 120a, and an upper wall 120b, which together form a vessel. Upper wall 120b includes an access opening 122 (FIGS. 10 and 12), which is normally closed and sealed by a removable cover 116. Cover 116 is configured to close access opening 122 in a manner that allows the interior of the keg to be pressurized, for example, so that it is rated up to about 120 psi, though the most kegs are actually pressurized to about 60 psi or less.

Stirrer assembly 114 is similarly removably mounted in cover 116 and includes a stirrer 118 that is driven by an electric motor assembly 130 and supported in cover 116 by a hub 146, described more fully below. Keg 112 also includes a conventional dispensing valve 138 and a tube 152, which extends from dispensing valve 138 to the bottom of keg 112. In order to provide clearance between tube 152 and stirrer assembly 114, stirrer assembly 114 is offset from the center of oval-shaped cover 116 and further titled in cover 116, as will be more fully described below.

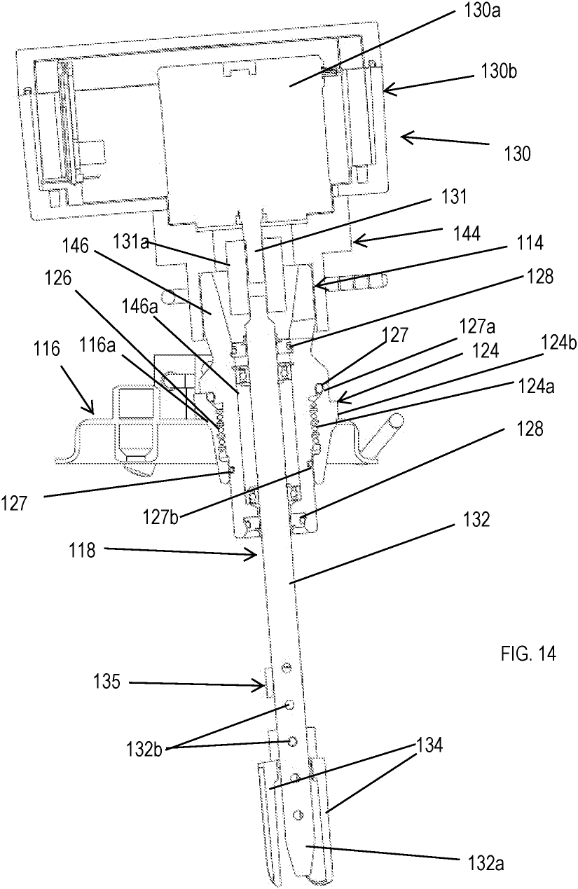

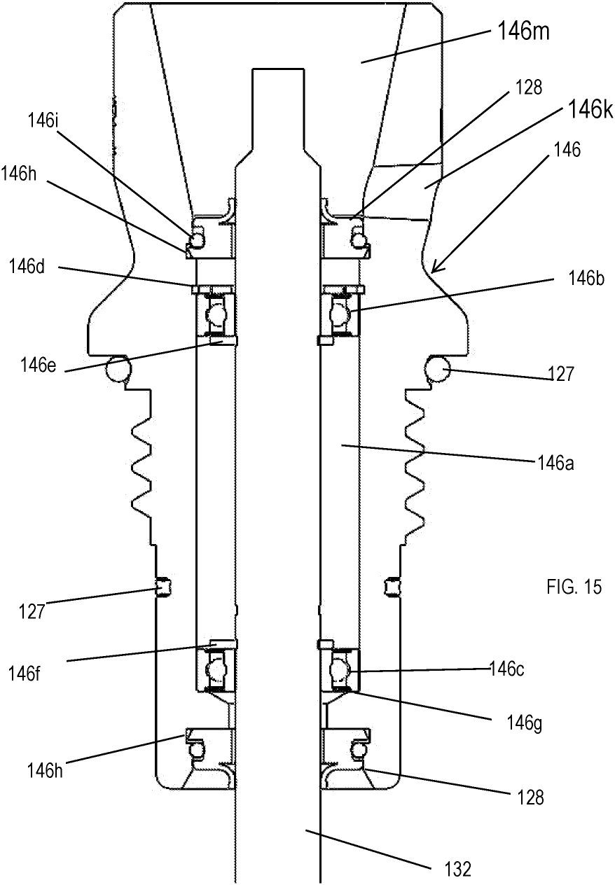

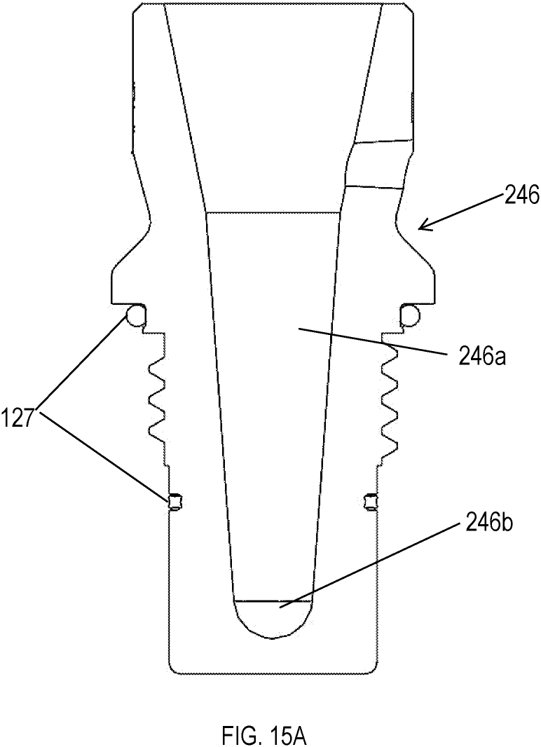

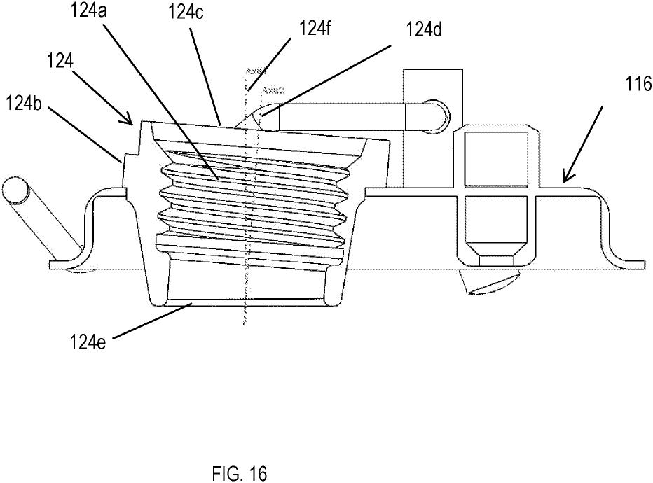

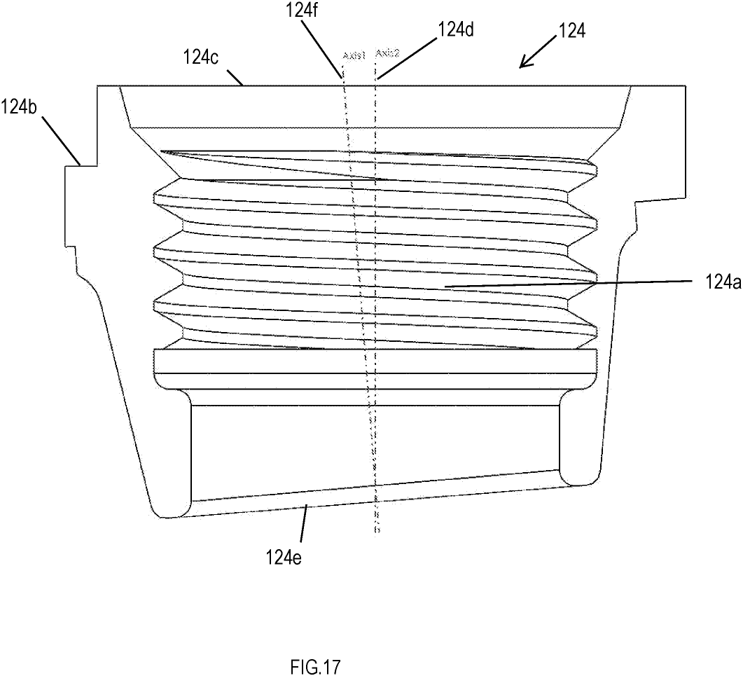

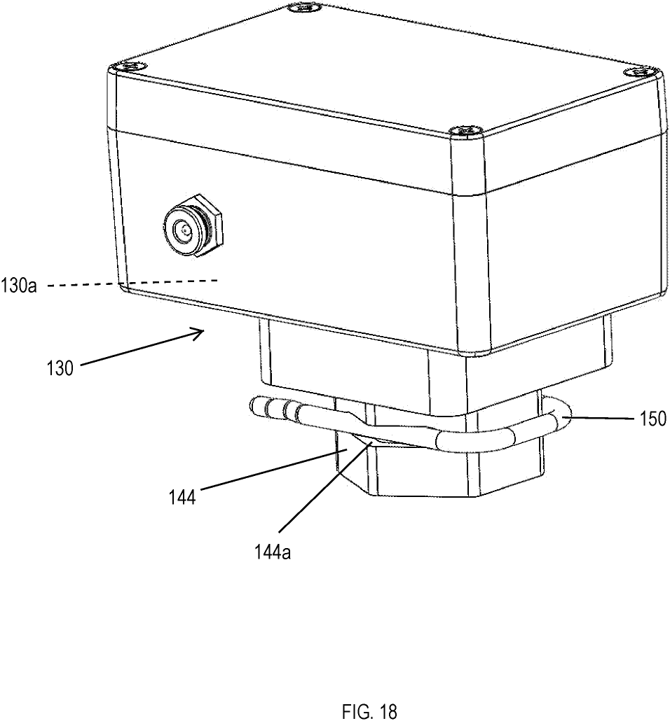

To mount stirrer assembly 114 in cover 116, cover 116 includes a through-hole 116a with a bushing 124 located in the through-hole 116a (FIG. 14) to provide a through-hole for stirrer 118. Bushing 124 has a passageway 124a (e.g. FIG. 16) that forms the through-hole and is configured to receive stirrer 118 there through and to sealingly engage the stirrer 118 via hub 146. Hub 146 is supported in passageway 124a by a threaded connection 126 (FIG. 14) and sealed in passageway 124a by one or more seals 127 (FIGS. 14 and 15), such as O-ring seals that seal hub 146 against respective upper and lower sealing surfaces 127a, 127b (FIG. 14) formed in bushing 124.

Similar to the previous embodiment, cover 116 is oval, and passageway 124a of bushing 124 is offset from the center of oval-shaped cover 116 to provide spacing between stirrer shaft 132, and paddles 134, and tube 152. Further as will be more fully described below, bushing 124 is configured to tilt stirrer assembly 114, and hence stirrer 118, to provide additional space and offset of stirrer 118 and its paddles 134 from tube 152, as well as wall 120.

Optionally, after stirrer assembly 114 is removed, a plug may be provided to fill the passageway 124a in the bushing 124. For example, referring to FIG. 15A, an additional hub 246 may be provided that is solid or is formed with a passageway 246a that does not extend or pass all the way through the hub 246 and has a terminal end 246b to provide a plug for the through-hole 124a in bushing 124. Hub 246 may also have seals 227 to seal the hub 246 in the through-hole 124a in the bushing 124. In this manner, the same mold that forms hub 146 may be used to form hub 246; however, it should be understood that hubs 146 and 246 may be formed from different molds provided that hub 246 has the same or similar outer geometry to seal through-hole 124a. For other details of hub 246 not mentioned herein, reference is made to hub 146. Alternately, an additional or second cover with no through-holes may be provided to seal the keg.

Bushing 124 may be formed from a generally cylindrical body with an annular flange 124b, which is welded to or formed in cover 116, and includes a threaded portion for forming the threaded connection 126. The threaded connection 126 between bushing 124 and stirrer assembly 114 is provided between a hub 146, which is mounted to the upper end of stirrer shaft 132, and bushing 124. Further, as noted and more fully described below, bushing 124 is configured to tilt stirrer assembly 114 so that longitudinal axis 114a of stirrer assembly 114 and mixing paddles 134 are angled relative to the central axis 112a of keg 112 at least in one plane (see FIG. 12) to avoid interference with tube 152 or wall 120 of keg 112.

Similar to paddles 34, paddles 134 are pivotally mounted to the stirrer shaft 132 in order to reduce the diameter of the stirrer 18 when the stirrer 18 passes through passageway 124a for insertion or removal of the stirrer assembly 14 to or from the keg. Hub 146 comprises a cylindrical body with a through passageway 146a to receive stirrer shaft 132 and is configured to allow rotation of stirrer shaft 132 therein, for example, using upper and lower bearings 146b and 146c, respectively. To retain stirrer shaft 132 in hub 146, an upper bearing 146b is mounted about stirrer shaft 132 and is captured between retaining ring 146e mounted to stirrer shaft 132 and retaining ring 146d mounted to hub 146. Similarly, a lower bearing 146c is mounted about stirrer shaft 132 and captured between retaining ring 146f mounted to stirrer shaft 132 and shoulder 146g formed in hub 146. In this manner, stirrer shaft 132 is free to rotate in hub 146 but is axially restrained in hub 146. The upper bearing 146b may provide an angular contact bearing to support the vertical force on the stirrer shaft 132 from gas pressure in the keg. Upper bearing 146b may also provide radial load support. The lower bearing 146c may be standard radial load bearings.

To seal stirrer shaft 132 in hub 146, upper and low annular seals 128, such as upper and lower annular lip seals, are mounted to hub 146. For example, when using lip seals, the seals may be held in place by snap fit connections with annular grooves 146h formed on the inside of hub 146. The lip seals may then be sealed against hub 146 by O-ring seals 146i located in annular groves formed in the lip seals, with the annular lips of the lip seals sealingly engaging stirrer shaft 132 to thereby seal stirrer shaft 132 in hub 146.

Optionally, hub 146 may have a hole 146k (FIG. 15) that extends from its exterior surface into passageway 146a above upper seal annular 128. When used as a hub with a stirrer assembly in a pressurized vessel, the end user can use the hole 146 to check for leaks. For example, the end user can cover the hole 146k with their finger, fill the top cavity 146m of the hub 146 with soapy water to check for bubbles, which would indicate a leak, then remove their finger to allow the water to drain through the hole.

To reduce seal wear, optionally the interface may be lubricated and/or coated, to reduce friction. The type of lubricant or coating can vary and will depend on the application. For example, hard coatings, such as diamond, nickel, titanium or gold coatings may be used in some applications. For beverages, the lubricant or coating must be food grade and FDA approved. Optionally, the shaft may be polished, including by electronic polishing, “passivation”, or other conventional method. Further, the material of the shaft may be selected to reduce or control friction-for example, a suitable material includes a ceramic, carbon fiber, a composite, such fiberglass, or plastic. In one form, a wear sleeve may be interposed between the shaft and the seals. In the case a wear sleeve is implemented, the stirrer shaft 132 may either be press-fit or have another set of O-rings or other mechanical seal to fully seal between the stirrer shaft 132 and the sleeve.

As noted above, bushing 124 is configured to tilt stirrer assembly 114 in keg 112. As best seen in FIG. 16, bushing 124 is formed from an asymmetrical, generally cylindrical body with transverse passageway 124a that forms an upwardly facing opening 124c, which is centered about an internal axis 124d, and a downwardly facing opening 124e which is also centered around internal axis 124d, Downwardly facing opening 124e, however, is angled with respect to a normal axis 124f (normal axis 124f is orthogonal to cover 116 and extends parallel to and spaced from longitudinal axis 112a of keg 112). Thus, passageway 124a is angled relative to normal axis 124f. In this manner, the external geometry of the bushing 124 is aligned along a different axis than its transverse passageway. Further, as understood, stirrer assembly 114 is, therefore, aligned with the internal axis 124d of bushing 124, and the internal sealing surfaces (127a, 127b), rather than the bushing’s external geometry so that stirrer assembly 114, as noted, is angled from the longitudinal axis 112a of keg 112 and offsets paddles 134 from tube 152.

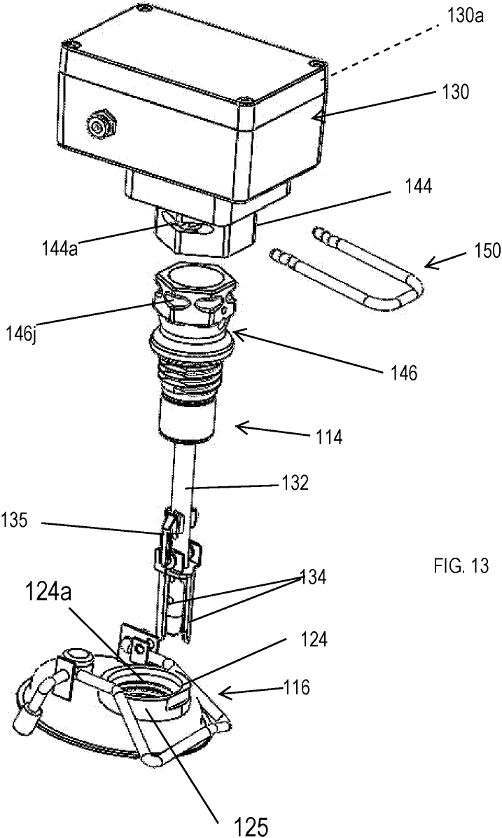

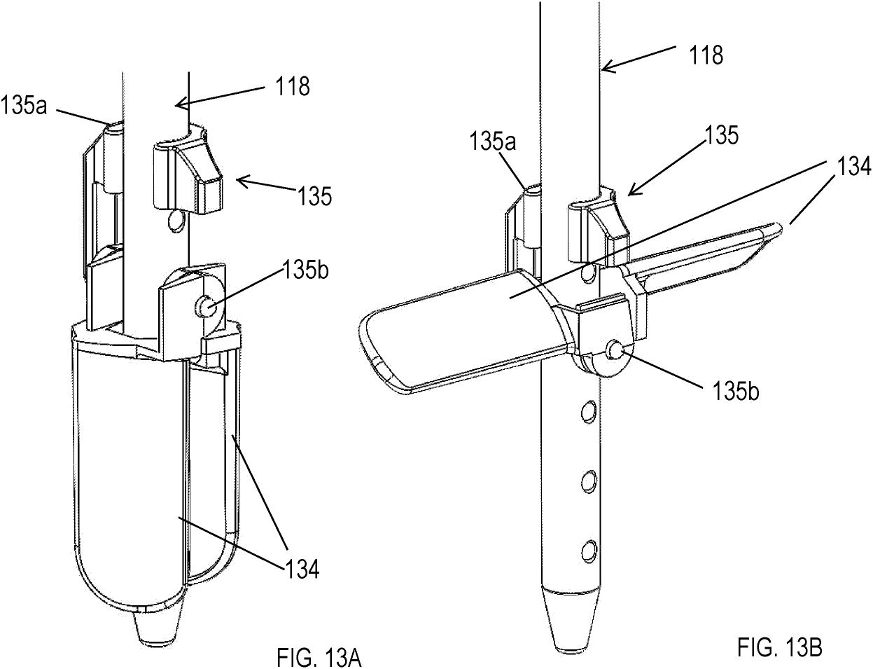

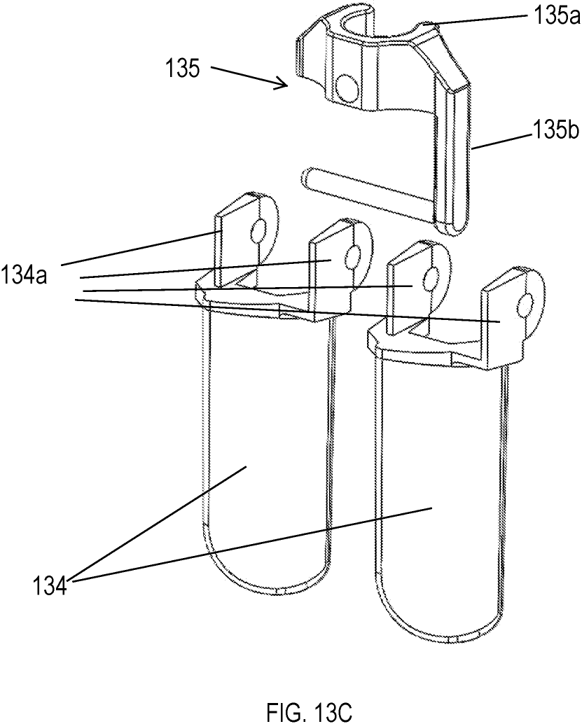

Or stated in another way-the external geometry of bushing 124 presents a circular boss 125 (FIG. 13) that mates to the through-hole 116a (i.e., circular hole) in the cover 116. When the bushing 124 is aligned properly, the interface between the circular boss and the lid are welded together. The internal geometry of the bushing 124, however, is not aligned with the external geometry of the bushing 124 and instead is tilted. Thus, when stirrer assembly 114 is installed, stirrer 118 is aligned to this tilt angle. The tilt angle is selected so that the blades do not hit or interfere with tube 152 also while not hitting or interfering with the wall 120 or bottom wall 120a of the keg. As noted, the tilt angle will be modified a bit once the keg is under pressure. This is the result of the keg cover deforming and the large O-ring seal on the cover compressing.

For example, passageway 124a may be offset relative to normal axis 124f at an angle in a range of about 0.5 degrees to 6 degrees, or optionally about 1.0 degree to 5 degrees, or about 4 degrees to 4.5 degrees, to offset stirrer 114 in keg by the same tilt angle or angular offset and, thus, locating paddles 134 in a region in keg 112 that is offset form the keg’s longitudinal axis 112a. In this manner, the paddles can avoid interference with tube 152 and also the wall 120 of keg 112. Additionally, it should be noted that when the keg is pressurized and the upper wall 120b tends to distort, so the in-operation angular offset may decrease.

Bushing 124 may be a monolithic metal (such as stainless steel) body that is machined with the described geometry-but it should be understood bushing 124 could be formed from multiple components (which are then joined together, e.g. by welding or threading) and/or cast or otherwise molded, such as blow molding, from a moldable material into its desired shape, especially when formed from a plastic material. Further, it should be understood that its shape or the angle of internal axis 124d relative to normal axis 124f may vary from vessel to vessel.

As best seen in FIGS. 10 and 12, the distal end or tip 132a of stirrer shaft 132 may extend the full length of cylindrical wall 120 and, optionally, to the interface between bottom wall 120a and cylindrical wall 120. In this manner the paddles 134 are close to the bottom of the keg (for example, within 0.5 to 4.5 inches or 1.0 to 2.5 inches of the lowest point of bottom wall 120a) so that the paddles provide an enhanced mixing performance and, further, can mix the liquid until the keg is nearly empty (for example, below about 5 % of capacity) because the paddles remain submerged or in contact with the fluid even at low fluid levels in the keg. When the keg is nearly empty, the blades will begin to fall to their natural “folded” position”. While the blades are not fully engaged with the fluid, it is expected the last couple of 8 to 12 oz drinks will still get some mixing action. It would be understood that optimal mixing occurs when the blades are fully submerged.

It should be understood that the depth of the tip (of stirrer 114) and angle of the stirrer can be modified depending on the shape of the tube. The shaft length and angle (as set by bushing 124) are typically locked-in during manufacturing. However, the position of the blades can be set by the end-user. During the design process, factors including the shape of the tube, size of the keg (or other vessel), or other potential interferences play roles in determining shaft length, angle, blade length, and expected blade mounting position.

Additionally, by being offset in the keg, the paddles induce mixing that results in the return liquid forming a return path on the other side of the keg. The position of the blades (low in the keg) with the angled shaft (towards one side of the keg) creates a circular flow of the mixed fluid. The flow passes downward through the blades, washes across the bottom of the keg (where the tip of the tube is), upwards on the opposite side of the blades in the keg and returns downward towards the blades. This circular flow (especially the washing effect across the lowest part of the keg), ensures the fluid is continually mixed homogenously.

As best seen in FIGS. 13A and 13B, paddles 134 are mounted to stirrer shaft 132 independently of each other and, further, in a manner so that they can be folded against stirrer shaft 132 of stirrer assembly 114 to allow stirrer shaft 132 to be sufficiently compact to pass though passageway 124a. In the illustrated embodiment, paddles 134 are mounted to stirrer shaft 132 by a mounting bracket 135. As best understood from FIGS. 13A, 13B, and 13C, bracket 135 includes a c-shaped clip 135a that engages the stirrer shaft 132 and an arm 135b, such as an L-shaped arm, that extends from the clip and extends into a selected transverse hole 132b formed in stirrer shaft 132 adjacent the distal end or tip 132a of stirrer shaft 132 to secure bracket 135 to stirrer shaft 132. Bracket 135 may be formed from plastic, such as by injection molding.

Paddles 134 each include tabs 134a with openings that receive arm 135b there through and mount paddles 134 to arm 135b on opposed sides of the stirrer shaft 132. In this manner, paddles 134 are able to freely swing so that they can pivot up and down due to the fluid forces on the paddles as stirrer shaft 132 is rotated by motor 130. For further details of the paddles not mentioned herein, reference is made to the first embodiment. Optionally any of the paddles described herein may be formed from plastic or another material that is less dense than the liquid to be mixed so the paddles rise up, as noted, when rotated due to the liquid forces on the hydrofoil shape of the paddles.

Optionally, stirrer shaft 132 includes multiple transverse holes 132b to allow the height of paddles to be adjusted to accommodate different size kegs, for example. In this manner, paddles 134 can be quickly and easily removed, and then cleaned and replaced on stirrer shaft 132 by simply unclipping bracket 135 from the stirrer shaft 132 and then pulling the arm 135b from the transverse hole 132b. Further, given that tubes may vary where they bend or curve inwardly (at their lower end), the space between any given tube and the central portion of the keg may vary. Consequently, the paddle locations may vary for each keg depending on where the tube is located and where it bends, and further how far into the center of the keg the tube extends.

Similar to the previous embodiment, electric motor assembly 130 may comprise a stepper motor 130a (FIG. 14), including a 12 or 24 volt stepper motor or brushless DC motor. Motor 130a includes a motor output shaft 131, which is configured to provide mating engagement with the upper end of stirrer assembly 114, in a similar manner to motor 30 and stirrer 14, via coupler 131a. As would be understood coupler 131a is configured to transmit torque to stirrer assembly 114 to rotate the stirrer 118. In this embodiment, the upward force is transmitted through the stirrer shaft 132 to the external snap ring 146e below bearing 146b, which is an angular contact bearing capable of supporting both axial and radial loads. The axial force is then transmitted through the bearing 146b to the hub 146 through internal snap ring 146d. That said, no axial force is applied to the motor output shaft 131. In this manner, should one of the keg components fail, the U-shaped pin 150 will keep the motor assembly 130 attached to the stirrer assembly hub 146 while keeping the stirrer shaft 132 fully contained within the keg. In this scenario, the keg assembly 110 can be shut down, pressure bled, and keg system safely disassembled.

As best seen in FIG. 14, motor assembly 130 includes a motor 130a enclosed and sealed in a housing 130b. Housing 130b is configured with a low profile so as to fit within the standard head room afforded kegs in most establishments, namely 8 to 9 inches above the keg. Referring to FIG. 13, motor assembly 130 also includes a socket 144 that is mounted to housing 130a, for example by welding, molding or gluing, or using fasteners. Socket 144 extends around motor shaft 131 and is sized to extend over and receive hub 146 of stirrer assembly 114 therein. The shape of socket 144 is such that it has at least one planar bearing surface that interfaces with at least planar bearing surface on the hub 146 so that it provides a torque transmitting interface for properly securing the hub 146 to cover 116. Optionally, the interface may be formed by a plurality of planar bearing surfaces, such as a hex shape interface.

To secure the socket 144 and hub 146 together along the longitudinal axis 114a of stirrer assembly 114, motor assembly 130 may include a U-shaped pin 150, similar to pin 50, and which may form a clip to couple socket 144 and hub 146 together when cover 116 is mounted to upper wall 120b of keg 120. U-shaped pin 150 extends through through-holes 144a formed in socket 144 to engage recesses 146j formed on hub 146. For further details of motor assembly 130 (and its motor controller) reference is made to the motor assembly 30 of the first embodiment.

For details of how keg assembly 110 can be used and disassembled for cleaning, reference is made to the description of the first embodiment.

It should be understood that the parts and components described herein made be formed from metal, such as stainless steel, or plastic or a composite material, as noted above, depending on this application and life expectancy.

Changes and modifications in the specifically described embodiments can be carried out without departing from the principles of the present invention which is intended to be limited only by the scope of the appended claims, as interpreted according to the principles of patent law including the doctrine of equivalents.

We claim:

1. A stirrer assembly for use with a vessel, the vessel having an access opening, said stirrer assembly comprising:
a cover that is adapted to close the access opening and having a through-hole therein; and
a stirrer assembly that is adapted to removably engage said through-hole, said stirrer assembly having a shaft adapted to be driven by a motor, and said shaft extending to a lower portion of the vessel and having at least one paddle at a distal portion of said shaft.

2. The stirrer assembly as claimed in claim 1, wherein said stirrer assembly engages said through-hole with mated threaded connection.

3. The stirrer assembly as claimed in claim 2, wherein said stirrer assembly is for use with a pressurized vessel, and said stirrer assembly further comprises a seal at said mated threaded connection to maintain pressure in the pressurized vessel when mounted in the pressurized vessel.

4. The stirrer assembly as claimed in claim 1, wherein said at least one paddle is pivotally mounted to said shaft and is movable between a non-operative position where said paddle can be passed through said through-hole and an operative position for stirring a liquid in the vessel.

5. The stirrer assembly as claimed in claim 4, wherein said at least one paddle defines a foil shaped surface that is adapted to pivot said at least one paddle into an orientation generally perpendicular to said shaft in response to rotation of said shaft.

6. The stirrer assembly as claimed in claim 1, further comprising a hub mounted to said driven shaft to align the stirrer with the motor shaft.

7. The stirrer assembly as claimed in claim 6, further in combination with a motor having a motor shaft, the stirrer assembly including a removable pin that is adapted to maintain engagement with said motor shaft.

8. The stirrer assembly as claimed in claim 1, wherein said cover is oval shaped, and wherein said through-hole is offset from a center of the cover.

9. The stirrer assembly as claimed in claim 1, wherein said cover has an upper facing side and a normal axis perpendicular to said upper facing side, and said through-hole is configured to tilt said stirrer assembly relative to said normal axis.

10. The stirrer assembly as claimed in claim 9, wherein said cover has a bushing forming said through-hole, said bushing having an external geometry aligned along said normal axis and an internal passageway forming said through-hole aligned along an axis angled relative to said normal axis.

11. A method of maintaining a liquid formulation in a mixed condition, the formulation comprising a liquid and a substance that is prone to separation from the liquid, said method comprising:
providing the formula in a vessel having an access opening;
closing the access opening with a cover having a through-hole therein;
providing a stirrer assembly;
positioning a stirrer assembly in said through-hole with the cover closing the access opening, said stirrer assembly having a motor driven shaft extending to a lower portion of the vessel and having a paddle at a distal portion of the motor driven shaft; and
at least occasionally driving the motor driven shaft to maintain the substance mixed with the liquid.

12. The method as claimed in claim 11 including replenishing the vessel by withdrawing the stirrer and removing the cover.

13. The method as claimed in claim 11 further comprising providing a bushing with a transverse passageway, and mounting the bushing in the cover thereby forming the though-hole in the cover with the transverse passageway.

14. The method as claimed in claim 13, wherein said providing a stirrer assembly comprises providing a stirrer assembly with a first hub with a through passageway to support and seal the motor driven shaft in the hub and to support and seal the motor driven shaft in the through-hole of the cover, further comprising providing a second hub without a through passageway, and replacing the stirrer assembly when removed from the through-hole in the cover with the second hub to form a plug in the through-hole of the cover.

15. The method as claimed in claim 11 further comprising a motor assembly for driving the motor driven shaft.

16. The method as claimed in claim 15 further including manually rotating the motor assembly to disengage the stirrer from the cover.

17. The method as claimed in claim 16 including separating the motor from the motor driven shaft and moving the motor to another stirrer on another vessel.

18. A vessel assembly comprising:
a vessel having an access opening;
a cover sealing said access opening, said cover having a through-hole;
a stirrer assembly mounted in said through-hole with a threaded, sealed engagement, said stirrer assembly having a stirrer, said stirrer having a shaft extending to a lower portion of the keg and at least one paddle at a distal portion of said shaft;
a motor to drive said shaft, wherein said shaft is adapted to be releasably coupled to said motor by a socket on one of said motor and said shaft and a mating hub on the other of said motor and said shaft.

19. The vessel assembly as claimed in claim 18, further comprising a removable pin that is adapted to maintain said socket and hub in a mated state.

20. The vessel assembly as claimed in claim 18, wherein said vessel forms a keg, such as a pressurized keg.
